(19) United States
(12) Patent Application Publication
(10) Pub. No.: US 2023/0235168 A1
(43) Pub. Date: Jul. 27, 2023

(54) PACKAGING

(71) Applicant: COLORMATRIX HOLDINGS, INC., Avon Lake, OH (US)

(72) Inventors: Mark DIXON, Knowsley Merseyside (GB); Adrian Carmichael, Knowsley Merseyside (GB)

(21) Appl. No.: 18/012,114

(22) PCT Filed: Jun. 28, 2021
(86) PCT No.: PCT/IB2021/055749

§ 371 Date: Dec. 21, 2022

(30) Foreign Application Priority Data
Jul. 22, 2020 (GB) 2011317.1

(51) Int. Cl. C08L 67/02; C08J 3/22; B65D 1/02; B65D 81/30; B65D 85/80

(52) U.S. Cl. CPC C08L 67/02; B65D 1/0207; B65D 81/30; B65D 85/80; C08J 3/226; C08J 2367/02; C08J 2467/02; C08L 2203/10

(57) ABSTRACT

Abstract: A container body which comprises a base and a side wall extending from the base, wherein said container body includes a polyester and a polymer YY. wherein said polymer YY is selected from the group comprising cyclic block copolymers (CBC) and cyclic olefin polymers (COP).

This invention relates to packaging and materials therefor. Preferred embodiments relate to containers, such as PET bottles, which are white in colour and are arranged to block and/or restrict light from entering the container to reduce the risk of the contents of the container degrading during storage due to exposure to light.

It is known to produce containers with light protection obtained by incorporating inorganic shielding fillers into PET. For example, EP3023458A1 relates to a single-layer plastic container with light shielding, wherein the procedure to incorporate a light-shielding filler is performed by adding, to a main PET plastic base, a concentrated additive that contains a high impact polystyrene (HIPS) and/or polypropylene (PP) polymer base in which inorganic shielding fillers that contain TiO₂ and Al have previously been dispersed.

Other plastic containers which address the same problem to protect their contents (e.g. UHT long-life milk) from light radiation are available in different plastic media and with different types of structures, for example: three-layer polyethylene, three-layer PET, two-layer PET or single-layer PET.

Conventionally, plastic containers which incorporate light protection have a white-coloured surface due to the fact that one of the most widespread uses for such containers is the bottling of long-life milk (e.g. UHT milk) and/or UHT milk products. There are known solutions to the problem in which TiO₂, a white pigment with a high concealing power, is combined with light absorbers that effectively reinforce the shield provided by the TiO₂. However, these light absorbers necessarily darken the surface of the containers rendering an unattractive and undesirable greyish colour and this means that the concentrations that can be used in the containers and hence the threshold of their efficacy are limited.

Commercially-available plastic bottles have tended to include relatively high levels of TiO₂ in view of its very high light blocking ability and its whiteness. Such TiO₂-containing bottles have excellent performance including very low light transmission (e.g. very low LT% at 550 nm) (i.e. high opacity) and high whiteness (e.g. high L*). However, legislation relating to the hazard classification of TiO₂ has made it desirable to endeavour to reduce the amount of TiO₂ in bottles. In addition, for recyclability reasons, it is desirable to reduce total levels of inorganic additives in general. However, solving such problems, especially in monolayer bottles, is challenging. In particular, whilst it is straightforward to produce highly opaque bottles, it is challenging to achieve both high opacity and high lightness. In addition, the Applicant has appreciated that, with certain formulations proposed to address the above-described problems, a further problem can become apparent, namely that the necks of blown bottles can appear less white compared to bottle walls. A significant (e.g. observable by the eye) contrast between the whiteness (or L*) of bottle necks and bottle side walls is aesthetically (and, therefore, commercially) unacceptable.

Cyclic-olefin copolymers (COCs) and polymethylpentene (PMP) have been proposed for use as opacifiers in bottles. However, Applicant has appreciated that the inclusion of such polymers in formulations for producing containers may increase the risk that a bottle will be produced with the above described unacceptable contrast between the whiteness of the bottle neck and the bottle wall.

It is an object of the present invention to address the above described problems.

According to a first aspect of the invention, there is provided a container body which comprises a base and a side wall extending from the base, wherein said container body includes a polyester and a polymer YY.

Said polyester is preferably a polyethylene terephthalate which term, in the context of the present specification, is intended to encompass co-polyethylene terephthalates. Co-polyethylene terephthalates of polyethylene terephthalate may contain repeat units from at least 85 mole% terephthalic acid and at least 85 mole% of ethylene glycol. Dicarboxylic acids which can be included, along with terephthalic acid, are exemplified by phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. Other diols which may be incorporated in the co-polyethylene terephthalates, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methyl pentane-1,4-diol, 2,2,4-trimethylpentane-1,3-diol, 2-ethylhexane-1,3-diol, 2,2-diethylpropane-1,3-diol, hexane-1,3-diol, 1,4-di(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4-hydroxypropoxyphenyl)-propane. In a preferred embodiment said polyethylene terephthalate has less than 10 mole%, more preferably less than 6 mole% especially less than 2 mole% comonomer substitution. Preferably, said co-polyethylene terephthalate does not comprise co-polyethylene terephthalate; it suitably comprises substantially a homopolymer produced by esterification or transesterification of terephthalic acid or dimethyl terephthalate and ethylene glycol to produce bis(2-hydroxyethyl) terephthalate which is then subjected to polycondensation at high temperatures in vacuum in the presence of a catalyst.

Said polyester may have a Tg of less than 90° C., for example of less than 85° C. The Tg may be at least 60° C. or 65° C.

The difference between the Tg of the polyester and that of said polymer YY (where said polymer has a Tg) may be at least 30° C.; the difference may be less than 90° C., or less than 60° C.

As used herein the term “IV” refers to the Inherent Viscosity of the polymeric material. It may be determined on a solution of 0.5 g of polymer dissolved in 100 ml of a mixture of phenol (60% by volume) and tetrachloroethane (40% by volume).

The IV of the polyester is preferably greater than 0.5 dL/g, more preferably greater than 0.65 dL/g.

Said polyester and said polymer YY are preferably not wholly miscible. Hence, a mixture comprising said polyester and said polymer YY may include observable regions of polymer YY dispersed in the polyester. Such regions may be observed by SEM. The observable regions of polymer YY may be particulate for example generally spherical.

Said polymer YY is preferably such that when dosed at 1 wt% into PET (eg PET-X referred to) as described in Examples 1 to 4 and bottles produced as described, the transmission, measured as described in Example 4, is reduced to less than 50% of the transmission of the PET alone.

Said polymer YY may have a Vicat Softening Temperature (VST) measured by ASTM D1525 of at least 110° C., at least 120° C., or at least 124° C. The VST may be less than 170° C. or less than 150° C. In a preferred embodiment, the VST is in the range 110-150° C., preferably In the range 120° C.-148° C.

The VST of said polyester may be 75-80° C. measured as aforesaid. The difference between the VST of the polymer YY and said polyester may be at least 40° C., suitably at least 50° C., preferably at least 55°..The difference may be less than 80° C. Said difference may be in the range 45-80° C., preferably in the range 50-75° C.

Said polymer YY may by selected from the group comprising cyclic block copolymers (CBC) and cyclic olefin polymers (COP) which are suitably as described below.

In one preferred embodiment, especially when said polymer YY is CBC or COP, said polymer YY may include monomer(s) which is/are hydrogenated to a level of greater than 90% or greater than 95%. Hydrogenation levels may be determined by UV-VIS spectroscopy and/or proton NMR analysis.

Said polymer YY may be CBC. Said CBC may comprise vinyl aromatic monomer units. The hydrogenation level of each vinyl aromatic monomer unit block may be greater than 90%. Said CBC may include a conjugated diene monomer unit and the hydrogenation level of the conjugated diene monomer unit may be greater than 95%. Said CBC may comprise hydrogenated styrene (e.g. to a level greater than 90%) and hydrogenated conjugated diene (e.g. to a level of greater than 95%) repeat units. The polymer may be made via anionic polymerisation.

Said CBC may have a structure

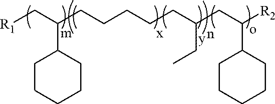

where R₁ and R₂ are end groups, and m, n, o, x and y, independently, are integers, for example in the range 1 to 100. Preferably, said CBC has the structure

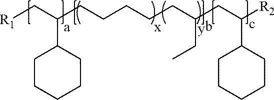

where R1 and R2 are end groups, and a, b, c, x and y are integers, suitably in the range 1 to 100.

Said CBC may have a Vicat softening temperature (1 kg, 50° C./hr) measured by ASTM D1525 of at least 115° C., preferably at least 120° C., more preferably at least 122° C. Said Vicat softening temperature may be less than 160° C. or less than 135° C.

Said CBC may have a Heat distortion temperature (0.455 MPa, 2° C./min) measured by ASTM D648 of at least 95° C., preferably at least 100° C. Said Heat distortion temperature may be less than 160° C.

Said polymer YY may be a COP. Said polymer YY may include a repeat unit of general formula

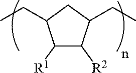

wherein R¹ and R² independently represent a H atom or an optionally-substituted, preferably unsubstituted, alkyl group, for example a C1-4 alkly group; and n is an integer. Said polymer YY may include at least 60 mol%, suitably at least 80 mol%, preferably at least 90 mol%, more preferably at least 95 mol%, or at least 99 mol% of repeat units of formula Q1. Said polymer YY may include at least 60 wt%, suitably at least 80 wt%, preferably at least 90 wt%, more preferably at least 95 wt%, especially at least 99 wt%, of repeat units of formula Q1. Said polymer YY preferably consists essentially of repeat units of formula Q1.

Said COP preferably includes less than 10 mol% of repeat units of structure —CH₂CH₂— and preferably includes 0 mol% of repeat units of structure —CH₂CH₂—.

Said COP may be a hydrogenated polynorbornene. The hydrogenation rate (eg the number of hydrogen bonds in the polynorbornene which are hydrogenated relative to the total number in the polynorbornene) is preferably at least 70%, more preferably at least 90%, especially at least 95 wt%. Hydrogenation rate may be assessed as described in US2005148746.

Said COP may have a Vicat softening temperature measured by ASTM D1525 of at least 130° C., preferably at least 140° C. Said Vicat softening temperature may be less than 160° C. or less than 150° C.

Said COP may have a Flexural Modulus measured by ASTM D790 of at least 1500 MP or at least 2000 MPa. The Flexural Modulus may be less than 2500 MPa.

Said COP may have a Glass Transition Temperature (Tg) measured by JIS K7121 of at least 120° C., preferably at least 130° C. The Tg may be less than 160° C. or less than 145° C.

A ratio (A) defined as the weight of polyester divided by the weight of polymer YY in the container body may be in the range 8 to 32, preferably in the range 15 to 30, more preferably in the range 15 to 25.

A ratio (B) defined as the weight of polyester divided by the weight of polymer YY in a layer of the container body may be in the range 8 to 32, preferably in the range 15 to 30, more preferably in the range 15 to 25. In preferred embodiments, said container body is defined by a single layer, in which case, said sidewall of the container body may consist of a single layer and ratio (B) suitably defines the weight of polyester divided by the weight of polymer YY in said single layer of the container body.

Said container body may include 1 to 10 wt% of polymer YY, preferably 3 to 8 wt% of polymer YY, more preferably 3 to 6 wt% of polymer YY. Said container body may include 85 to 97 wt% of polyester. Said container body may include 88 to 96 wt% of polyester, 3 to 8 wt% of polymer YY and 1 to 7 wt% of other ingredients. In one preferred embodiment, said container body includes 88.0 to 94.0 wt% of polyester, 3.0 to 6.0 wt% of polymer YY and 1.0 to 7.0 wt% of other ingredients.

A single layer of said container body may include 1 to 10 wt% of polymer YY, preferably 3 to 8 wt% of polymer YY, more preferably 3 to 6 wt% of polymer YY. Said single layer of said container body may include 85 to 97 wt% of polyester. Said single layer may include 88 to 96 wt% of polyester, 3 to 8 wt% of polymer YY and 1 to 7 wt% of other ingredients. In one preferred embodiment, said single layer includes 88.0 to 94.0 wt% of polyester, 3.0 to 6.0 wt% of polymer YY and 1.0 to 7.0 wt% of other ingredients.

The sum of the wt% of thermoplastic polymers (eg polyester and polymer(s) YY) in said container body may be at least 88 wt%, preferably at least 92 wt%, more preferably at least 94 wt%. The sum may be less than 99 wt% or less than 97 wt%.

Said container body may include a first light shielding pigment. Such a pigment may interact with incident light by primarily diffracting light and optionally scattering and/or absorbing. Diffraction occurs as a result of a difference in refractive index between the light shielding pigment and the polyester or polymer YY. Light shielding pigments may solely diffract, as in the case of titanium dioxide (TiO₂), or they may both scatter and absorb, as in the case of black iron oxide (PBlk 11). Some examples of light shielding pigments include titanium dioxide (TiO₂), ultramarine blue (PB 29), metal oxide particles such as red iron oxide (PR 101), black iron oxide (PBlk 11), chromium green-black hematite (PG 17), cobalt aluminate (PB 28), aluminium trihydrate (AI(OH)3), barium sulfate (BaS04), zinc sulphide (ZnS), zinc oxide, metal flake (eg aluminium or bronze flakes), calcium carbonate and mica.

Said first light shielding pigment is preferably zinc sulphide (ZnS). Said first light shielding pigment preferably includes at least 95 wt%, especially at least 99 wt% zinc sulphide (ZnS).

Said container body may include less than 8 wt%, preferably less than 6 wt%, more preferably less than 5 wt%, especially no more than 4.5 wt% of said first light shielding pigment. Said container body may include at least 1 wt% or at least 2 wt% of said first light shielding pigment. Said container body may include 2 to 5 wt% of said first light shielding pigment.

Said container body may include less than 2 wt%, preferably less than 1.5 wt%, more preferably no greater than 1.0 wt% of titanium dioxide. Said container body may include 0 to 2 wt%, preferably 0 to 1.5 wt%, of titanium dioxide. In one embodiment, said container body may include 0 wt% of titanium dioxide

A single layer of said container body may include less than 8 wt%, preferably less than 6 wt%, more preferably less than 5 wt%, especially no more than 4.5 wt% of said first light shielding pigment. A single layer of said container body may include at least 1 wt% or at least 2 wt% of said first light shielding pigment. A single layer of said container body may include 2 to 5 wt% of said first light shielding pigment.

A single layer of said container body may include less than 8 wt%, preferably less than 6 wt%, more preferably less than 5 wt%, especially no more than 4.5 wt% of zinc sulphide. A single layer of said container body may include at least 1 wt% or at least 2 wt% of said zinc sulphide. A single layer of said container body may include 2 to 5 wt% of said zinc sulphide.

Said container body may include a second light shielding pigment. Said second light shielding pigment may be selected from titanium dioxide (TiO₂), ultramarine blue (PB 29), metal oxide particles such as red iron oxide (PR 101), black iron oxide (PBlk 11), chromium green-black hematite (PG 17), cobalt aluminate (PB 28), aluminium trihydrate (Al(OH)3), barium sulfate (BaS04), zinc sulphide (ZnS), zinc oxide, metal flake (eg aluminium or bronze flakes), calcium carbonate and mica. Said first and second light shielding pigments are preferably different and/or do not include all of the same elements.

Said second light shielding pigment is preferably particulate metal, for example a metal flake, for example particulate aluminium or aluminium flake. Said second light shielding pigment preferably includes at least 95 wt%, especially at least 99 wt% aluminium.

Said container body may include less than 1.0 wt%, preferably less than 0.50 wt%, more preferably less than 0.050 wt% of said second light shielding pigment. Said container body may include at least 0.001 wt% or at least 0.025 wt% of said second light shielding pigment. Said container body may include 0.025 to 0.50 wt% of said second light shielding pigment.

The sum of the wt% of light shielding pigments (eg said first, said second and/or any other light shielding pigments) in said container body may be less than 8 wt%, preferably less than 6 wt%, especially less than 5 wt%. The sum may be at least 1 wt% or at least 3 wt%. The sum may be in the range 2.0 to 4.0 wt%.

In one embodiment, said container body includes 88-93 wt% of said polyester (eg PET), 1-6 wt% zinc sulphide, 3-7 wt% of said polymer YY and 0.01 to 0.2 wt% of particulate aluminium (eg flake).

In a preferred embodiment, said container body includes 88-93 wt% polyester (eg PET), 2-5 wt% zinc sulphide, 4-7 wt% of polymer YY,and 0.01 to 0.10 wtt% of particulate aluminium (eg flake).

As described, said container body comprises said polyester. Said container body preferably comprises polyester as the major thermoplastic polymer in the container body. Polyester (especially PET) preferably makes up at least 75 wt%, preferably at least 85 wt%, of the total wt% of thermoplastic polymers in the container body.

Said container body may define a receptacle for example a bottle, suitably excluding any closure (e.g. cap) thereof. Said container body may include a ridged, for example screw-threaded, neck arranged to cooperate with a closure, for example a screw-threaded closure.

Said container body and/or a sidewall thereof preferably includes only one layer of material which suitably defines the container body (excluding any closure for the container body). Thus, said container body and/or a sidewall thereof preferably do not include any laminated region or multi-layered region.

Said container body preferably comprises and/or is defined by a mixture, for example a substantially homogenous mixture, of said polyester, said polymer YY and, when provided, said first light shielding pigment and said second light shielding pigment.

In one embodiment, there is provided a container body which comprises a base, a side wall extending from the base and a neck portion arranged to engage a closure for the container body, wherein said container body includes a polymer YY and polyester (eg PET), wherein the side wall of the container body has an L* of at least 90 and the neck portion has an L* of at least 84.

The L* of the container body may be assessed using a reflectance technique (suitably so the thickness of any sample is not generally relevant) as described in Test 2 hereinafter.

The L* of the neck portion of the container body is suitably taken to be the L* of the side wall of a preform from which the container body is blown. It may be assessed as described in Test 1 hereinafter.

To reduce the risk the lightness of the side wall is too light compared to the lightness of the neck (which may lead to the container body being aesthetically unacceptable due to the lightness contrast between side wall and neck), the difference between the L* of the side wall and preform is suitably less than a predetermined level as determined by Applicant. The difference is suitably less than 12, suitably less than 10, preferably less than 9, especially 8 or less.

The L* of the side wall of the container body may be at least 90 or at least 92. The L* may be less than 98, less than 96 or less than 94. The L* may be in the range 90 to 95.

The L* of the neck portion may be at least 83, preferably at least 84, more preferably at least 85. The L* of the neck portion may be less than 90 or 88. The L* of the neck portion may be in the range 83-89 or 83-87.

A first ratio defined as the L* of the side wall of the container body divided by the L* of the neck portion may be at least 1.03 or at least 1.05; it may be less than 1.15 or less than 1.10.

The difference between the b* of the side wall of the container body and the neck portion of the container body may be greater than 1.0. It may be less than 3.0.

The difference between the b* of the side wall of the container body and the neck portion of the container body may be less than 1.0.

Said container body preferably has a light transmission (LT%) at 550 nm as described in Test 3 of less than 1.0%, preferably less than 0.5%, more preferably less than 0.2%.

Said neck portion is suitably a portion of the container body which includes said polyester (eg PET) which is substantially, preferably entirely, unstretched (eg in a blow molding process) and/or is suitably substantially identical to the neck portion in a preform from which the container body is blown.

Said neck portion preferably extends from an open end of the container body, suitably inwards. It may extend a distance of at least 1 cm or at least 1.5 cm. A second ratio, defined as the total length of the container body (suitably measured from the base to the neck portion) divided by the length of the neck portion may be at least 5 or at least 10.

Said neck portion preferably includes grooves, for example, screw-threads for releasably engaging a closure.

Said container body may have volume in the range 0.1 to 5 litres or in the range 0.2 to 1.5 litres.

Said container body may comprise virgin polyester or recycled polyester, for example PET.

Said container body is preferably part of a beverage container. It may have a volume of no more than 5 litres, for example no more than 2 litres or no more than 1 litre.

Said container body for example a sidewall thereof, may have a thickness of at least 100 microns or at least 200 microns. The thickness may be less than 500 microns or less than 400 microns or less than 398 microns. The thickness may be in the range 102 to 398 microns and may comprise PET.

The neck of said container body may have a maximum internal diameter of at least 10 mm or at least 15 mm. The maximum internal diameter may be less than 70 mm. The maximum internal diameter may be in the range 11 to 40 mm. The footprint of the bottle (when stood on its base) may have an area in the range 1000 to 10000 mm³. The ratio defined as the maximum internal diameter of the neck divided by the area of the footprint of the bottle may be in the range 0.001 to 0.04.

The invention extends, in a second aspect, to a container comprising a container body according to the first aspect, wherein a closure is secured, for example releasably secured, to the container body.

The container may include a beverage. It may include at least 100 ml or at least 500 ml of beverage. The beverage may include at least 90 wt% water. The beverage may include at least 0.1 wt% for example at least 1 wt% fat. It may include less than 10 wt% fat. Said beverage is preferably a milk, for example animal milk.

According to a third aspect of the invention there is provided a preform for making a container body, for example according to the first aspect or second aspect, the preform comprising:
(i) a polyester;
(ii) a polymer YY (eg CBC or COP which are suitably as described herein).

The L* of the preform may be at least 83, preferably at least 84, more preferably at least 85. The L* of the preform may be less than 90 or 88. The L* of the preform may be in the range 83-89 or 83-87.

Said preform preferably includes polyester (eg PET) which is substantially, preferably entirely, unstretched.

A neck portion of said preform preferably includes grooves, for example, screw-threads for releasably engaging a closure.

Polyester may be as described in the first aspect. It is preferably PET.

Polymer YY may be as described in the first aspect. It is preferably CBC or COP.

A ratio (A) defined as the weight of polyester divided by the weight of polymer YY in the preform may be in the range 8 to 32, preferably in the range 15 to 30, more preferably in the range 15 to 25.

Said preform may include 1 to 10 wt% of polymer YY, preferably 3 to 8 wt% of polymer YY, more preferably 3 to 6 wt% of polymer YY. Said preform may include 85 to 97 wt% of polyester. Said preform may include 88 to 96 wt% of polyester, 3 to 8 wt% of polymer YY and 1 to 7 wt% of other ingredients. In one preferred embodiment, said preform includes 88.0 to 94.0 wt% of polyester, 3.0 to 6.0 wt% of polymer YY and 1.0 to 7.0 wt% of other ingredients.

A single layer of said preform may include 1 to 10 wt% of polymer YY, preferably 3 to 8 wt% of polymer YY, more preferably 3 to 6 wt% of polymer YY. Said single layer of said preform may include 85 to 97 wt% of polyester. Said single layer may include 88 to 96 wt% of polyester, 3 to 8 wt% of polymer YY and 1 to 7 wt% of other ingredients. In one preferred embodiment, said single layer includes 88.0 to 94.0 wt% of polyester, 3.0 to 6.0 wt% of polymer YY and 1.0 to 7.0 wt% of other ingredients.

In said preform, said polyester and said polymer YY are preferably not wholly miscible. Hence, a mixture comprising said polyester and polymer YY may include observable regions of polymer YY dispersed in the polyester. Such regions may be observed by SEM. The observable regions may be particulate for example generally spherical.

The sum of the wt% of thermoplastic polymers (eg polyester(s)), CBC or COP) in said preform may be at least 88 wt%, preferably at least 92 wt%, more preferably at least 94 wt%. The sum may be less than 99 wt% or less than 97 wt%.

Said preform preferably comprises a polyester as the major thermoplastic polymer in the preform. Polyester (especially PET) preferably makes up at least 75 wt%, preferably at least 85 wt%, of the total wt% of thermoplastic polymers in the preform.

Said preform and/or a sidewall thereof preferably includes only one layer of material which suitably defines the preform. Thus, said preform and/or a sidewall thereof preferably do not include any laminated region or multi-layered region.

Said preform may include a first light shielding pigment. Such a pigment may be as described in the first aspect.

Said first light shielding pigment is preferably zinc sulphide (ZnS). Said first light shielding pigment preferably includes at least 95 wt%, especially at least 99 wt% zinc sulphide (ZnS).

Said preform may include a second light shielding pigment. Such a pigment may be as described in the first aspect.

Said second light shielding pigment is preferably particulate metal, for example a metal flake, for example particulate aluminium or aluminium flake. Said second light shielding pigment preferably includes at least 95 wt%, especially at least 99 wt% aluminium.

The sum of the wt% of light shielding pigments (eg said first, said second and/or any other light shielding pigments) in said preform may be less than 8 wt%, preferably less than 6 wt%, especially less than 5 wt%. The sum may be at least 1 wt% or at least 3 wt%. The sum may be in the range 2.0 to 5.0 wt%.

Said preform may include less than 2 wt%, preferably less than 1.5 wt%, more preferably no greater than 1.0 wt% of titanium dioxide. Said preform may include 0 to 2 wt%, preferably 0 to 1.5 wt%, of titanium dioxide. In one embodiment, said preform may include 0 wt% of titanium dioxide.

In one embodiment, said preform includes 88-93 wt% polyester (eg PET), 1-6 wt% zinc sulphide, 3-7 wt% of polymer YY, 0.01 to 0.2 wt% of particulate aluminium (eg flake).

In a preferred embodiment, said preform includes 88-93 wt% polyester (eg PET), 2-5 wt% zinc sulphide, 4-7 wt% of polymer YY,, 0.01 to 0.10 wtt% of particulate aluminium (eg flake).

Said preform for example a sidewall thereof, may have a thickness of at least 1 mm, at least 2 mm or at least 3 mm. The thickness may be less than 5 mm.

The neck of said preform may have a maximum internal diameter of at least 10 mm or at least 15 mm. The maximum internal diameter may be less than 70 mm. The maximum internal diameter may be in the range 11 to 40 mm.

According to a fourth aspect of the invention, there is provided a formulation for use in a method of making a preform according to the third aspect, the formulation comprising a polymer YY (eg CBC or COP) which is suitably as described in the first aspect.

Said formulation may include a first light shielding pigment as described in the first aspect. Said first light shielding pigment is preferably zinc sulphide. .Said formulation may include at least 10 wt%, preferably at least 15 wt%, more preferably at least 20 wt%, especially at least 25 wt% of said first light shielding pigment. Said formulation may include less than 50 wt%, preferably less than 45 wt%, more preferably less than 42 wt%, of said first light shielding pigment.

Said formulation may include a second light shielding pigment as described in the first aspect. Said second light shielding pigment is preferably particulate metal, for example a metal flake, for example particulate aluminium or aluminium flake. Said second light shielding pigment preferably includes at least 95 wt%, especially at least 99 wt% aluminium. Said formulation may include at least 0.05 wt%, preferably at least 0.1 wt%, more preferably at least 0.15 wt%, of said second light shielding pigment. Said formulation may include less than 1 wt%, preferably less than 0.50 wt%, more preferably less than 0.45 wt%, of said second light shielding pigment.

Said formulation preferably includes less than 20 wt%, preferably less than 15 wt%, more preferably less than 12 wt% titanium dioxide.

Said formulation preferably includes less than 5 wt%, preferably 0 wt% of polyester, for example PET.

Said formulation may include 40-70 wt% of polymer YY (eg CBC or COP), 20-50 wt% of said first light shielding pigment, 0.05-1 wt% of said second light shielding pigment, and 0-15 wt% of titanium dioxide.

Said formulation may include 45-65 wt% of polymer YY (eg CBC or COP), 25-45 wt% of said first light shielding pigment, 0.10-0.50 wt% of said second light shielding pigment, and 0-11 wt% of titanium dioxide.

Said formulation may include 55-64 wt% of polymer YY (eg CBC or COP), 25-45 wt% of said first light shielding pigment, 0.10-0.50 wt% of said second light shielding pigment, and 0-11 wt% of titanium dioxide.

Said formulation may include 55-64 wt% polymer YY (eg CBC or COP), 30-45 wt% of said first light shielding pigment, 0.10-0.50 wt% of said second light shielding pigment, and less than 1 wt% (preferably 0 wt%) of titanium dioxide.

Said formulation is preferably in the form of pellets.

According to a fifth aspect of the invention, there is provided a method of making a container body of the first aspect, the method comprising:
(i) selecting a preform according to the third aspect;
(ii) stretch blow moulding the preform to produce the container body of the first and/or second aspect.

Preferably, during said stretch blowing moulding the preform is not heated to a temperature which is greater than the Tg of the polymer YY (when polymer YY has a Tg). Said preform is preferably stretch blow moulded at a temperature which is less than the Tg of the polymer YY. Preferably, during said stretch blowing moulding the preform is not heated to a temperature which is greater than 130° C., or greater than 125° C. Said preform is preferably stretch blow moulded at a temperature which is less than 130° C., preferably less than 125° C.

Preferably, during said stretch blowing moulding, the preform is not heated to a temperature which is greater than the Vicat Softening Temperature (VST) of the polymer YY. Said preform is preferably stretch blow moulded at a temperature which is less than the VST of the polymer YY. Preferably, during said stretch blowing moulding the preform is not heated to a temperature which is greater than 130° C., or greater than 125° C. Said preform is preferably stretch blow moulded at a temperature which is less than 130° C., preferably less than 125° C.

The method may comprise selecting a formulation according to the fourth aspect and contacting said formulation with polyester as described according to the first aspect. The method may comprise contacting 5 to 15 wt% of said formulation with 85 to 95 wt% of polyester. The method may comprise contacting 7 to 12 wt% of said formulation with 88 to 93 wt% of polyester.

According to a sixth aspect of the invention, there is provided a method of making a formulation according to the fifth aspect, the method comprising contacting said polymer YY (eg CBC or COP), with said first light shielding pigment and/or other ingredients in the formulation. The method may comprise mixing said polymer YY (eg CBC or COP), with said first light shielding pigment and/or other ingredients. The method may comprise extruding said polymer YY (eg CBC or COP), with said first light shielding pigment and/or other ingredients in the formulation. An extrudate may be formed into pellets which may comprise masterbatch pellets.

Any feature of any aspect of any invention or embodiment described herein may be combined with any feature of any aspect of any other invention or embodiment described herein mutatis mutandis.

Specific embodiments of the invention will now be described, by way of example, with reference to the accompanying drawings, in which:

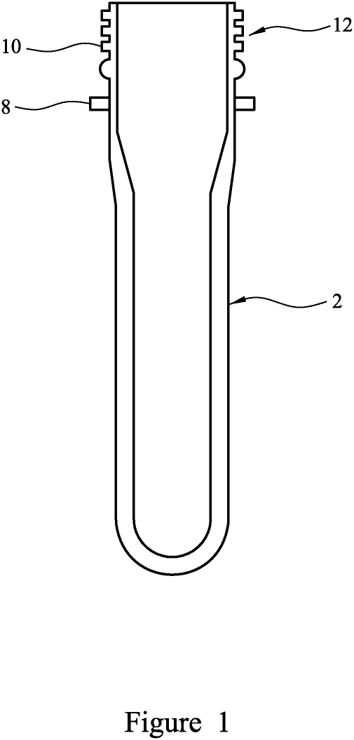

FIG. 1 is a cross-section through a preform;

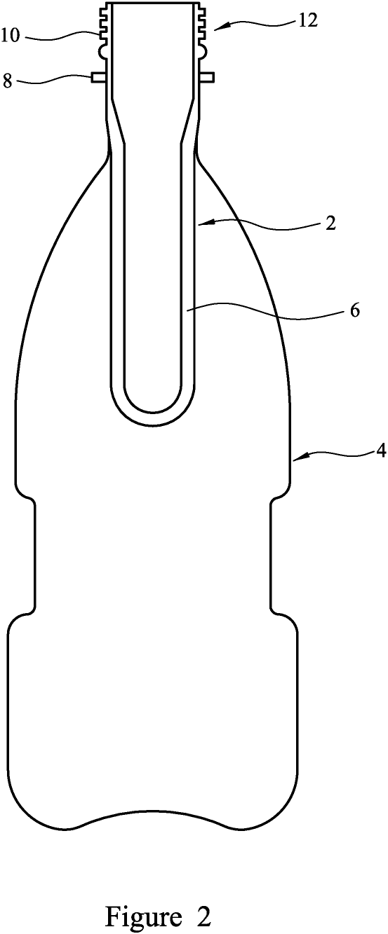

FIG. 2 shows the preform of FIG. 1 superimposed on a bottle blown from the preform to illustrate that a neck of the preform is unchanged on blowing to produce a bottle;

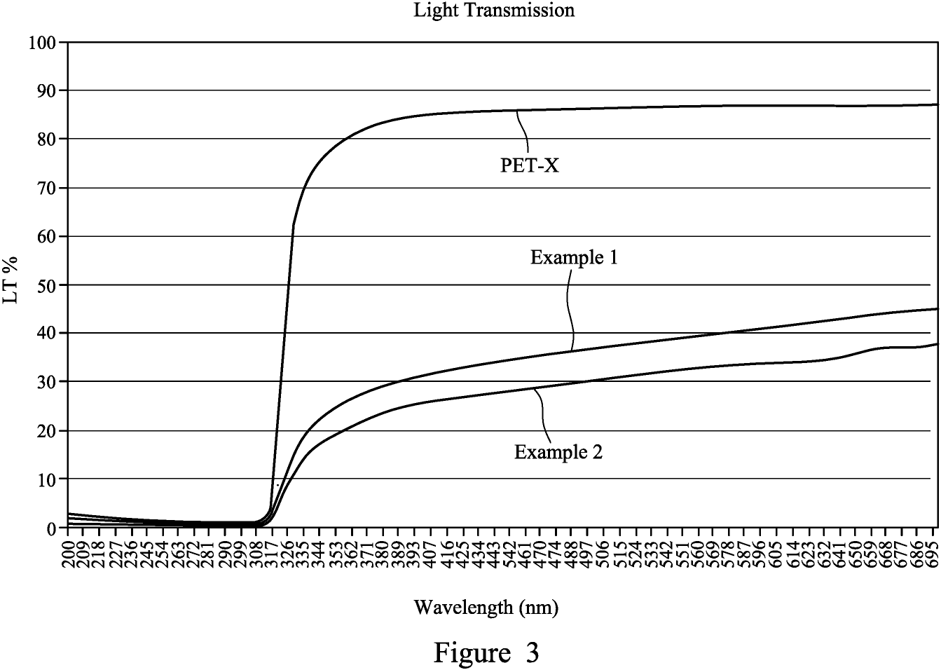

FIG. 3 includes graphs of light transmission v. wavelength for bottles of Examples 1 to 3.

The following materials are referred to hereinafter:

PET-X - refers to a proprietary bottle grade PET (Lighter C93 from Equipolymers, with an Intrinsic Viscosity (IV) of 0.80 +/- 0.02).

Cyclic block copolymer (CBC) – refers to ViviOn 1325 from USI Group/Mitsui. The material is a block copolymer of styrene and conjugated diene, with the following properties:

| | | |
|---|---|---|
| Property | Test Method (ASTM) | Value |
| Density | D792 | 0.94 g/cm³ |
| Melt Flow Rate (2.16 kg, 260° C.) | D1238 | 7 cm³/10 min |
| Vicat softening temperature (1 kg, 50° C./hr) | D1525 | 126° C. |
| Heat distortion temperature (0.455 MPa, 2° C./min) | D648 | 102.5° C. |

Cyclic Olefin polymer (COP) – refers to Zeonor 1420R from Zeon. The material has the following properties:

| | | |
|---|---|---|
| Property | Test Method | Value |
| Glass transition temperature (Tg) | JIS K7121 | 136° C. |
| Melt Flow Rate | JIS K6719 (280° C., 21.18 V) | 20 g/10 min |
| Flexural Modulus | ASTM D790 | 2200 MPa |
| Vicat Softening Point | ASTM D1525 | 145° C. |

Aluminium paste – refers to STAPA WM Chromal Aluminium flake comprising 80 wt% +/- 2 wt% aluminium pigment and 20 wt% +/- 2 wt% medical white oil and other additives. 98 wt% of the particles can pass though a 45 micron sieve. The D10 is approximately 4 microns; the D50 approximately 13 microns; and the D90 approximately 28 microns.

Tioxide TR28 – a surface treated fine crystal rutile titanium dioxide obtained from Huntsman.

Zinc sulphide – SACHTOLITH HD-S supplied by Venator.

Referring to FIG. 1, a preform 2 for a blow-molded PET bottle 4 (FIG. 2) includes a body 6 which is arranged to expand when the preform 2 is heated in a bottle mold. Above the body 6 is a ring 8 which is generally held by a machine (not shown) during liquid filling of the blow-molded bottle. Above the ring 8 is a cap region 10 with grooves arranged to cooperate with a bottle cap for releasably closing the bottle. Neck region 12 is a portion of the preform 2 which includes cap region 10 and does not expand during blow molding of the preform to produce the bottle. Thus, as illustrated by comparing FIGS. 1 and 2, the neck region 12 is substantially the same size and shape in both the preform and blow-molded bottle. FIG. 2 includes annotated typical preform/bottle dimensions in mm.

The following tests are referred to herein:

### Test 1 - L* A* B* Colour Space Assessment of Preforms

Preform colour is measured using a Minolta CM2600d spectrophotometer in reflectance mode using D65 illuminant. A preform is positioned on a metal frame (with the main elongate axis of the preform extending substantially horizontally. This allows the spectrophotometer to be positioned in contact with the preform wall at the point of the spectrophotometer aperture. L*, a* and b* values are recorded.

### Test 2 - L* A* B* Colour Space Assessment of Blow-Molded Bottle

A small (60 mm × 60 mm) square section is cut from a bottle wall. This section is placed on the holder of a Minolta CM3600A spectrophotometer, with the outer surface of the bottle section towards the instrument aperture. The Large Area View (LAV) aperture is used, and the colour of the sample is measured in reflectance mode using D65 illuminant. L*,a* and b* values are recorded.

### Test 3 - Measurement of Light Transmission of Blow-Molded Bottle

Light transmission of each bottle is assessed on a cut section from the bottle wall, using a Shimadzu UV Visible Spectrophotometer with an integrating sphere, across the wavelength range 300 - 700 nm.

### Examples 1 and 2 - Preparation of Preforms

Preforms are manufactured in a Husky GL160 injection moulder, with a two cavity mould installed. PET-X (99 wt%) was premixed manually with 1 wt% of selected polymers and manually added into a hopper installed above the feed throat of the injection moulder machine. A standard PET injection moulding process was employed to produce preforms.

The selected polymers were as follows:

| Example No | Selected polymer |
|---|---|
| 1 | Cyclic Block Copolymer (CBC) |
| 2 | Cyclic Olefin polymer (COP) |

### Example 3 -Producing Bottles From Preforms

The preforms of Examples 1 and 2 were stretch blow moulded using a Sidel SB01 blow moulding machine into a 1 litre cylindrical bottle. A standard blowing process was utilised. The overall power % of the heating ovens was adjusted to achieve a preform temperature of 115° -120° C. as the preform exits the oven and before it enters the blow mould. This is referred to as the blowing temperature.

### Example 4 - Assessment of Bottles

A small section was cut from each bottle wall produced as described in Example 3 and the wall thickness measured using a Magna Mike. A typical wall thickness was 200 - 300um. The small sections were then measured for light transmission using a Shimadzu UV Visible Spectrophotometer with an integrating sphere, across the wavelength range 300 - 700 nm. A light transmission of 50% is considered a good result, as it indicates a significant reduction in light transmission compared to a PET-only wall section.

Results are provided in FIG. 3. The figure shows that addition of the polymers of Examples 1 and 2 to PET-X significantly reduces light transmission (and so increases opacity) of the bottle walls.

The polymers of Examples 1 and 2 can, in view of the result described, be formulated with other ingredients to produce formulations which can advantageously be used to produce masterbatches, preforms and bottles as described below.

### Example 5 - General Procedure for Preparing Masterbatch Formulations

A premix is prepared where polymer raw materials are weighed and manually mixed together with some of the other materials, aluminium paste and zinc sulphide. The extrusion line is a ZE25UTXi 50D twin screw extruder with a main feeder and a side feeder. The premix is introduced into the extruder via the main feeder and the titanium dioxide (if applicable) is introduced via the side feeder. The extrusion process is a PET process. The strands are cooled down in a water bath and pelletized in a standard pelletizer.

### Examples 6 and 7 - Preparation of Masterbatch Formulations

Following the general procedure referred to in Example 5, a range of masterbatch formulations can be prepared as described below.

| Example No. | Identity of polymer | Amount of polymer (wt%) | Trioxide TR28 (wt%) | Zinc Sulphide (wt%) | Aluminium paste (wt%) |
|---|---|---|---|---|---|
| 7 | CBC or COP | 55.7 | 11 | 33 | 0.3 |
| 8 | CBC or COP | 55.7 | 0 | 44 | 0.3 |

### Examples 8 and 9 - Preparation of Preforms

The masterbatch formulations of Examples 6 and 7 can be used to produce preforms at a let-down-ratio (LDR) of 9%. 91 wt% of PET-X is compounded with 9 wt% of the formulations of Examples 6 and 7 and preforms manufactured in a Husky GL160 injection moulder machine, with a two cavity mould installed.

Preform compositions are detailed below.

| Example No. | Masterbatch of example used | Composition of bottle | | | | | |
|---|---|---|---|---|---|---|---|
| | | Amount of polyester PET-X | Identity of other polymer | Amount of other polymer (wt%) | Trioxide TR28 (wt%) | Zinc Sulphide (wt%) | Aluminium paste (wt%) |
| 8 | 6 | 90.97 | CBC or COP | 5 | 1 | 3 | 0.03 |
| 9 | 7 | 90.97 | CBC or COP | 5 | 0 | 4 | 0.03 |

### Examples 10 - Production of Bottles

Following the procedure referred to in Example 3, the preforms of Examples 8 and 9 can be blown into bottles and assessed. The bottles produced have excellent opacity and whiteness. In addition, the neck portions of the bottles are sufficiently similar in colour to the body of the bottle to be aesthetically acceptable – ie to the naked eye, any differences in colour as between the neck and body of the bottle were not significant enough to lessen the perceived aesthetic acceptability of the bottle.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A container body which comprises a base and a side wall extending from the base, wherein said container body includes a polyester and a polymer YY.

2. A container body according to claim 1, wherein said polymer YY is such that when dosed at 1 wt% into PET as described in Examples 1 to 4 and bottles produced as described, the transmission, measured as described in Example 4, is reduced to less than 50% of the transmission of the PET alone.

3. (canceled)

4. A container body according to claim 1, wherein the difference between the Tg of the polyester and that of said polymer YY is at least 30° C.; and/or wherein said polymer YY has a Vicat Softening Temperature (VST) measured by ASTM D1525 of at least 110° C.; and/or wherein the difference between the Tg of the polymer YY and said polyester is at least 30° C.

5. (canceled)

6. (canceled)

7. A container body according to claim 1, wherein said polymer YY is selected from the group comprising cyclic block copolymers (CBC) and cyclic olefin polymers (COP).

8. (canceled)

9. A container body according to claim 1, wherein said polymer YY is CBC, wherein said CBC comprises vinyl aromatic monomer units, wherein the hydrogenation level of each vinyl aromatic monomer unit block is greater than 90%; and said CBC includes a conjugated diene monomer unit and the hydrogenation level of the conjugated diene monomer unit is greater than 95%; and/or wherein said CBC has the structure 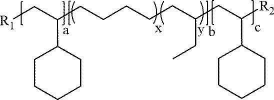
where R1 and R2 are end groups, and a, b, c, x and v are integers in the range 1 to 100.

10. (canceled)

11. A container body according to claim 1, wherein said polymer YY includes a repeat until of general formula 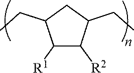
wherein n is an integer; and/or wherein polymer YY is a COP which includes less than 10 mol% of repeat units of structure —CH₂CH₂—.

12. (canceled)

13. A container body according to claim 1, wherein:
a ratio (B) defined as the weight of polyester divided by the weight of polymer YY in a layer of the container body is in the range 8 to 32; said container body is defined by a single layer; and said container body includes 88.0 to 94.0 wt% of polyester, 3.0 to 6.0 wt% of polymer YY and 1.0 to 7.0 wt% of other ingredients.

14. (canceled)

15. (canceled)

16. A container body according to claim 1, wherein:
the sum of the wt% of thermoplastic polymers in said container body is at least 88 wt% and the sum is less than 99 wt%
; said container body includes a first light shielding pigment which is zinc sulphide; and
said container body includes less than 8 wt% of said first light shielding pigment; and includes at least 1 wt% of said first light shielding pigment.

17. (canceled)

18. (canceled)

19. A container body according to claim 16, wherein:
-said container body includes less than 2 wt% of titanium dioxide; and
said container body includes a second light shielding pigment which is a particulate metal.

20. (canceled)

21. A container body according to claim 19, wherein said container body includes less than 0.050 wt% of said second light shielding pigment; and the sum of the wt% of light shielding pigments in said container body is less than 5 wt%.

22. (canceled)

23. A container body according to claim 1,
wherein said container body includes 88-93 wt% polyester, 1-6 wt% zinc sulphide, 3-7 wt% of polymer YY, 0.01 to 0.2 wt% of particulate aluminium.

24. A container body according to claim 1, wherein
said container body includes 88-93 wt% polyester, 2-5 wt% zinc sulphide, 4-7 wt% of polymer YY, 0.01 to 0.10 wt% of particulate aluminium.

25. A container body according to claim 1, wherein:
said container body is part of a beverage container, having a volume of no more than 5 litres; and
a sidewall of said container body has a thickness of at least 100 microns; and less than 500 microns.

26. A container body according to claim 1, wherein:
-said container body has a light transmission (LT%) at 550 nm as described in Test 3 of less than 1.0%; and/or said container body comprises a base, a side wall extending from the base and a neck portion arranged to engage a closure for the container body, wherein said container body includes a polymer YY and polyester, wherein the side wall of the container body has an L* of at least 90 and the neck portion has an L* of at least 84.

27. (canceled)

28. (canceled)

29. A container comprising a container body according to claim 1, wherein a closure is secured to the container body; and said container includes a beverage which includes at least 0.1 wt% fat and/or is a milk.

30. A preform for making a container body, according to claim 1, the preform comprising:
(i) a polyester;
(ii) a polymer YY.

31. A preform according to claim 30, wherein:
-a ratio (A) defined as the weight of polyester divided by the weight of polymer YY in the preform is in the range 8 to 32; and/or said preform includes 88 to 96 wt% of polyester, 3 to 8 wt% of polymer YY and 1 to 7 wt% of other ingredients; and/or
comprises a first light shielding pigment which is zinc sulphide (ZnS) and a second light shielding pigment which is particulate metal.

32-36. (canceled)

37. A formulation for use in a method of making a preform according to claim 30, the formulation comprising a polymer YY, wherein said formulation includes 55-64 wt% polymer YY, 30-45 wt% of a first light shielding pigment which is zinc sulphide and 0.10-0.50 wt% of a second light shielding pigment which is particulate metal.

38-41. (canceled)

42. A container body according to claim 1, which comprises a base and a side wall extending from the base, wherein:
said container body includes PET and a polymer YY;
said polymer YY is selected from the group comprising cyclic block copolymers (CBC) and cyclic olefin polymers (COP);
a ratio (B) defined as the weight of PET divided by the weight of polymer YY in a layer of the container body is in the range 15 to 25;
said container body is defined by a single layer; and
said container body includes 88.0 to 94.0 wt% of PET, 3.0 to 6.0 wt% of polymer YY and 1.0 to 7.0 wt% of other ingredients.

43. A container body according to claim 42, wherein:
said container body includes 88-93 wt% PET, 2-5 wt% zinc sulphide, 4-7 wt% of polymer YY and 0.01 to 0.10 wtt% of particulate aluminium.
a closure is secured to the container body; and said container includes a beverage which includes at least 0.1 wt% fat and/or is a milk.
